(19) United States
(12) Patent Application Publication
(10) Pub. No.: US 2026/0243097 A1
(43) Pub. Date: Aug. 20, 2026

(54) Foldable self-checkout kiosk

(71) Applicant: TOSHIBA GLOBAL COMMERCE SOLUTIONS, INC., Durham, NC (US)

(72) Inventors: William L. DUNGAN, Cary, NC (US); Craig Walton TURNER, Raleigh, NC (US); Jack RATCLIFFE, Tarboro, NC (US); Kevin J. GIERL, Cary, NC (US)

(21) Appl. No.: 19/058,869

(22) Filed: Feb. 20, 2025

(51) Int. Cl. E04H 1/12; A47F 9/04; H04N 23/51; H04N 23/90

(52) U.S. Cl. CPC E04H 1/1222; A47F 9/04; H04N 23/51; H04N 23/90

(57) ABSTRACT

A foldable self-checkout kiosk is provided. In one aspect, a foldable self-checkout kiosk includes a base, a back panel, and a halo. The back panel is pivotably coupled with the base for rotation about a first pivot axis so that the back panel is movable relative to the base between a folded position and an unfolded position. The halo is pivotably coupled with the back panel for rotation about a second pivot axis so that the halo is movable relative to the back panel between a folded position and an unfolded position.

### BACKGROUND

Many retail stores offer buyers the option to purchase items at self-service kiosks. Self-service kiosks have become desirable to both buyers and retailers. For buyers, the kiosks offer reduced wait times as compared to using a cashier lane, Retailers can benefit from increased checkout efficiencies. During a checkout transaction, a buyer can scan product barcodes for each product and can place them on a platform to be weighed and/or monitored during the transaction. One or more cameras of the self-service kiosk can be used to identify products, capture biometric data of buyers, and monitor the checkout transaction overall.

### BRIEF DESCRIPTION OF THE DRAWINGS

FIG. 1 illustrates a perspective view of an exemplary foldable self-checkout kiosk arranged in a deployed position, according to one or more aspects of the present disclosure.

FIGS. 2 and 3 illustrate a perspective view and a side view of the foldable self-checkout kiosk of FIG. 1, respectively, with a halo thereof arranged in a folded position.

FIGS. 4 and 5 illustrate a perspective view and a side view of the foldable self-checkout kiosk of FIG. 1, respectively, with a back panel thereof and the halo arranged in folded positions such that the foldable self-checkout kiosk is arranged in a stowed position.

FIG. 6 illustrates a close-up view of a lower hinge of the of the foldable self-checkout kiosk of FIG. 1.

FIG. 7 illustrates a close-up view of an upper hinge of the of the foldable self-checkout kiosk of FIG. 1.

FIG. 8 illustrates a close-up view of the back panel of the foldable self-checkout kiosk of FIG. 1.

FIGS. 9 and 10 illustrate a side view and a perspective view of an exemplary foldable self-checkout kiosk, according to one or more aspects of the present disclosure.

FIG. 11 is a flow diagram for a method, according to one or more aspects of the present disclosure.

FIG. 12 is a block diagram of a computing device according to example embodiments of the present disclosure.

### DETAILED DESCRIPTION

Self-service kiosks can include various components that facilitate interactive checkout transactions. For example, a self-service kiosk can include a platform with one or more load cells for weighing items, one or more cameras for monitoring and identifying items moved into a “buy zone”, a camera for capturing biometric data of a buyer, a display for presenting information to buyers, guidance lights to help guide buyers through a checkout transaction, etc. Such self-service kiosks may be moved or transported from time to time, such as during initial delivery from a factory to a retail store or during a checkout remodel or rearrangement. When being transported or stored, it can be desirable to “break down” or disassemble a self-service kiosk to make them easier to move and to protect components thereof. Breaking down and transporting some self-service kiosks has proven to be less than optimal, and in some instances, experienced technicians are needed to perform relatively complex disassembly and/or reassembly. Moreover, some self-service kiosks have relatively large packaging footprints, taking up valuable space, or alternatively, are broken down into many separate pieces.

Disclosed herein are self-service kiosks that include features that address one or more of the noted challenges. The self-checkout kiosks of the present disclosure can include features that enable a unit to be readily folded up for storage or transport and to be unfolded for use. In this regard, the self-checkout kiosks of the present disclosure can be deemed “foldable” self-checkout kiosks. In one or more examples, a self-checkout kiosk can include foldable sections, including a base, a back panel, and a halo that overhangs the base. The back panel can be pivotably coupled with the base for rotation about a first pivot axis so that the back panel is movable relative to the base between a folded position and an unfolded position. The halo can be pivotably coupled with the back panel for rotation about a second pivot axis so that the halo is movable relative to the back panel between a folded position and an unfolded position. These foldable sections can be strategically folded to facilitate efficient breakdown of the unit, with none or relatively few parts needed for disassembly. In this way, an unskilled person can readily disassemble the unit. Moreover, the foldable sections can be folded in such a way that protection of high-value components (e.g., cameras, display, load cells, etc.) of the self-checkout kiosk can be achieved during storage or transport. The foldable sections can be strategically folded to shield the high-value components from damage. The foldable sections can also be unfolded in a repeatable and intuitive manner for setup of the unit, which can eliminate or reduce the need for experienced technicians for setup of a unit. In addition, the foldable nature of the foldable self-checkout kiosk can provide a more compact package for storage or transport. In addition, the foldable sections can remain coupled even when the foldable self-checkout kiosk is in the stowed position, reducing the time needed for disassembly/assembly of the unit. Other advantages, benefits, and/or technical effects are contemplated.

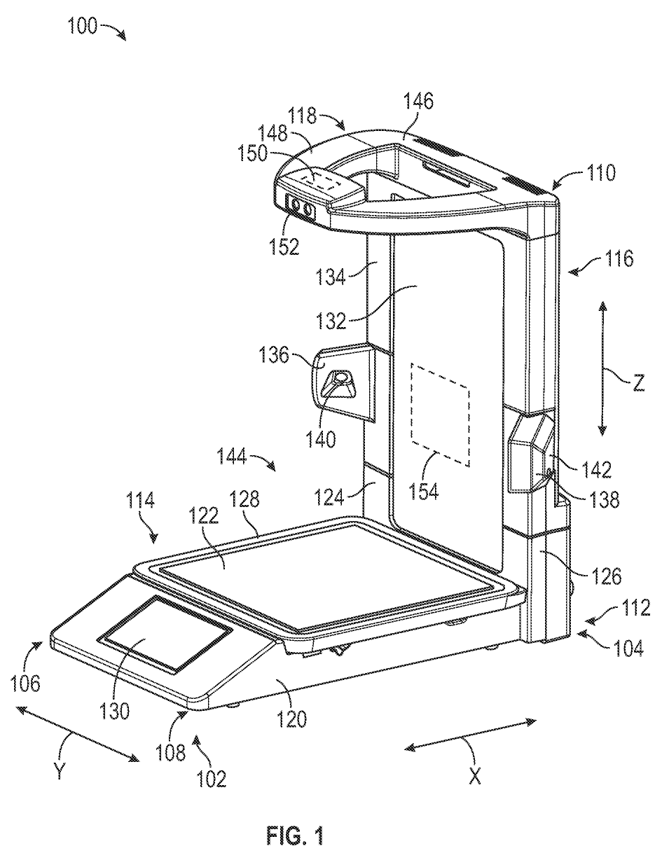

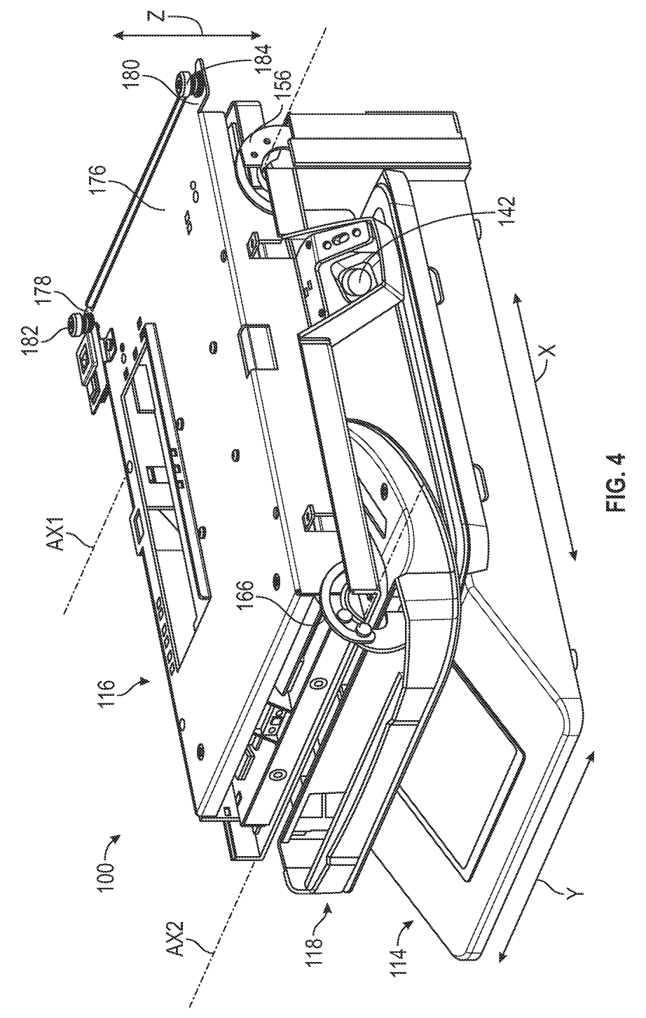

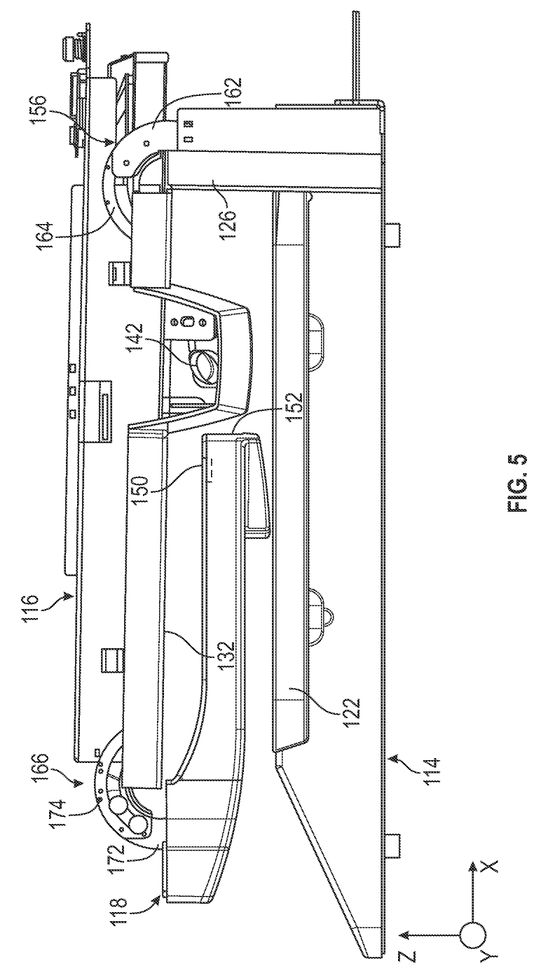

Turning now to the drawings, FIG. 1 illustrates a perspective view of an exemplary foldable self-checkout kiosk 100 according to one or more aspects of the present disclosure. The foldable self-checkout kiosk 100 can also be referred to as a self-service kiosk, a checkout terminal, or a self-checkout system. For reference, the foldable self-checkout kiosk 100 defines an X-direction, a Y-direction, and a Z-direction, which are mutually perpendicular to one another. In one or more examples, the X-direction is a transverse direction, the Y-direction is a lateral direction, and the Z-direction is a vertical direction. In FIG. 1, the foldable self-checkout kiosk 100 is depicted in a deployed position, but as will be explained further herein, the foldable self-checkout kiosk 100 is movable to a stowed position (FIGS. 4 and 5), with one or more sections of the foldable self-checkout kiosk 100 being foldable to transition the foldable self-checkout kiosk 100 into the compact stowed position.

As shown in FIG. 1, the foldable self-checkout kiosk 100 has a front 102 and a back 104, a first side 106 and a second side 108 (e.g., a left side and a right side), and a top side 110 and a bottom side 112. The foldable self-checkout kiosk 100 includes a base 114, a back panel 116, and a halo 118. With the foldable self-checkout kiosk 100 in the deployed position as illustrated in FIG. 1, the back panel 116 is arranged substantially perpendicular to the base 114, and the halo 118 is arranged substantially perpendicular to the back panel 116 and parallel with the base 114.

The base 114 includes has a housing 120, a platform 122 arranged on the housing 120, and posts 124, 126. The posts 124, 126 are each arranged at the back 104 of the foldable self-checkout kiosk 100 and each extend upward relative to the housing 120, e.g., along the Z-direction. The posts 124, 126 are spaced from one another, e.g., along the Y-direction. The platform 122 can be arranged to facilitate a self-service checkout transaction and can also be used to guide a shopper through the process. In at least one example, the platform 122 can include one or more load cells for sensing the weight of one or more items placed thereon, and can also include a guidance light 128 arranged about its perimeter. The guidance light 128 can be controlled to selectively illuminate to guide a shopper through a transaction, such as by illuminating certain colors to indicate a status, e.g., illuminating green when an item has been successfully scanned or reregistered, red when an item has not been successfully scanned, and blue when showing system readiness for item scanning. The base 114 can also include any combination of one or more user input devices 130, for example, a touch screen, keypad, card reader, and/or near-field receiver. The shopper may communicate with the foldable self-checkout kiosk 100 using any of the user input devices 130. For example, the user input devices 130 may be configured to tender payment methods.

The back panel 116 has a display 132 supported by a display housing 134. The display 132 can present information to a shopper during the checkout process. For example, the display 132 can present an updated checkout list, checkout instructions, and/or payment instructions to a shopper during a checkout transaction. The back panel 116 also has a pair of arms 136, 138 extending outward from the display housing 134 in opposite directions. The arms 136, 138 support side cameras 140, 142, respectively. The side cameras 140, 142 are disposed on opposite sides of the display 132. The side cameras 140, 142 are arranged to capture right and left viewpoint images of a predefined zone 144 or “buy zone”. In this way, images of items placed within the predefined zone 144 can be captured, and such images can be used for item recognition.

The halo 118 has an attachment portion 146 and an overhang portion 148. The attachment portion 146 is coupled with a top end of the back panel 116 and the overhang portion 148 extends out over the platform 122. As depicted in FIG. 1, the overhang portion 148 overhangs the platform 122. The attachment portion 146 and the overhang portion 148 collectively form a ring-like shape. The halo 118 can include one or more cameras. In one or more examples, the halo 118 includes an overhead camera 150 arranged to capture overhead viewpoint images of the predefined zone 144 or items placed on or near the platform 122. The overhead camera 150 is depicted schematically in FIG. 1. In addition, the halo 118 can include one or more forward-facing cameras 152 oriented in a forward-facing position, e.g., to capture images of the shopper present at the foldable self-checkout kiosk 100. In this way, biometric data can be captured. The cameras 140, 142, 150, 152 can be configured to capture images based on an indication that one or more items have been detected in the predefined zone 144, or that a shopper has approached within a predetermined proximity of the foldable self-checkout kiosk 100, or based on the load cells sensing items on the platform 122, or a combination thereof, or some other trigger condition.

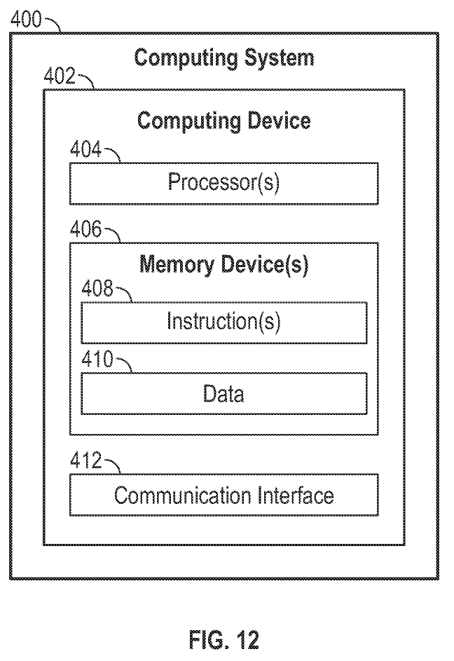

The foldable self-checkout kiosk 100 can also include a computing system 154, which can be arranged in the back panel 116, such as behind the display 132. The computing system 154 is depicted schematically in FIG. 1. The computing system 154 can also be arranged in other locations, such as in the base 114 underneath the platform 122. The computing system 154 can be arranged in a same or similar manner as the computing system 400 of FIG. 12, for example.

In at least some examples, the computing system 154 and the cameras 140, 142, 150, 152 can form part of a computer vision system of the foldable self-checkout kiosk 100. Images captured by the cameras 140, 142, 150, 152, which can be still images or frames of a video, can be routed to the computing system 154 for processing. The computing system 154 can use the captured images, e.g., to identify the one or more items placed on or near the platform 122. Feedback from the load cells can also be fed to the computing system 154 for processing. In addition, captured images can be compared to baseline images, e.g., to determine whether one or more of the cameras 140, 142, 150, 152 are in their respective predefined deployed alignments.

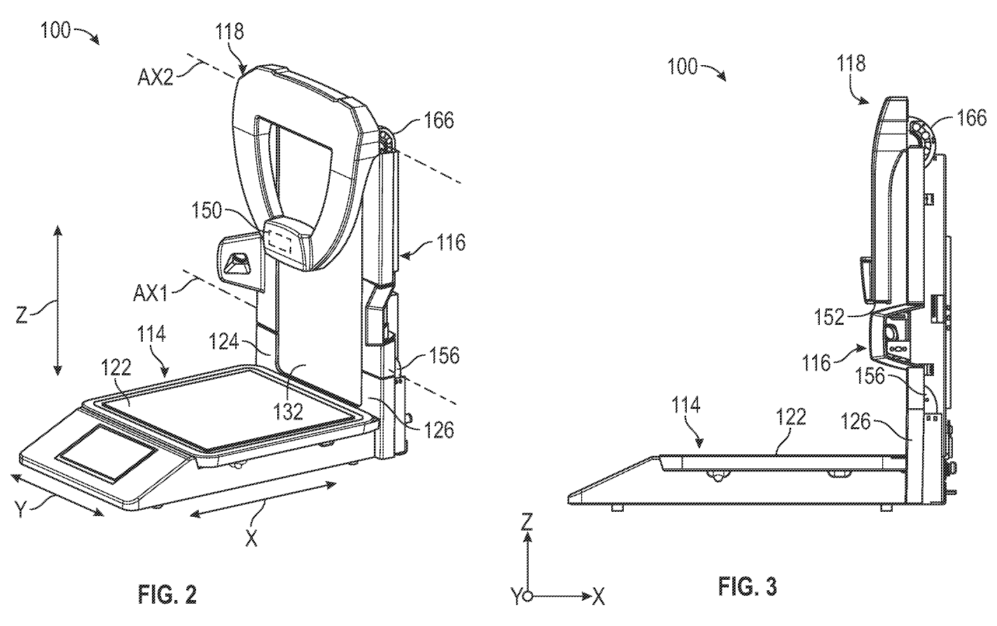

With reference now to FIGS. 1, 2, 3, 4, and 5, aspects of the foldable self-checkout kiosk 100 that enable the foldable self-checkout kiosk 100 to transition from a stowed position to a deployed position, or vice versa, will now be described in detail. FIGS. 2 and 3 illustrate a perspective view and a side view of the foldable self-checkout kiosk 100, respectively, with the halo 118 arranged in a folded position. FIGS. 4 and 5 illustrate a perspective view and a side view of the foldable self-checkout kiosk 100, respectively, with the back panel 116 and the halo 118 arranged in their respective folded positions such that the foldable self-checkout kiosk 100 is in a stowed position. The foldable self-checkout kiosk 100 is in a deployed position in FIG. 1, as noted previously.

In one or more examples, the back panel 116 can be pivotably coupled with the base 114 for rotation about a first pivot axis AX1 so that the back panel 116 is movable relative to the base 114 between a folded position and an unfolded position. The first pivot axis AX1 can extend along the Y-direction, for example. In FIGS. 1, 2, and 3, the back panel 116 is shown in the unfolded position. In the unfolded position, the back panel 116 is arranged substantially perpendicular to the base 114, such as at least within ten degrees (10°) of ninety degrees (90°), e.g., as shown in FIG. 3. In FIGS. 4 and 5, the back panel 116 is depicted in the folded position. In the folded position, the back panel 116 is arranged substantially parallel to the base 114, such as at least within ten degrees (10°) of one another. In FIG. 5, the back panel 116 is depicted in its folded position and arranged substantially parallel to the base 114.

To facilitate the folding and unfolding action of the back panel 116 relative to the base 114, the foldable self-checkout kiosk 100 can include lower hinges 156. The lower hinges 156 can be disposed along the first pivot axis AX1 and can be arranged to pivotably couple the back panel 116 with the posts 124, 126 of the base 114. In at least one example, the lower hinges 156 can include a first lower hinge and a second lower hinge. The first lower hinge can be disposed, at least in part, in the post 124 arranged at the first side 106 while the second lower hinge can be disposed, at least in part, in the post 126 arranged at the second side 108. While only the second lower hinge is visible in FIGS. 2, 3, 4, and 5, it will be appreciated that the first lower hinge can be arranged in a similar position at the first side 106. In FIGS. 2, 3, 4, and 5, a back cover of the foldable self-checkout kiosk 100 has been omitted for illustrative purposes.

In one or more examples, the lower hinges 156 are arranged to be concealed within the posts 124, 126 and back panel 116 when the back panel 116 is in the unfolded position, e.g., as shown in FIG. 1. In FIG. 1, the lower hinges 156 are not visible. In this regard, the lower hinges 156 can be “invisible hinges” that can be hidden from view when the foldable self-checkout kiosk 100 is in the deployed position, which can enhance the safety of the foldable self-checkout kiosk 100, among other benefits.

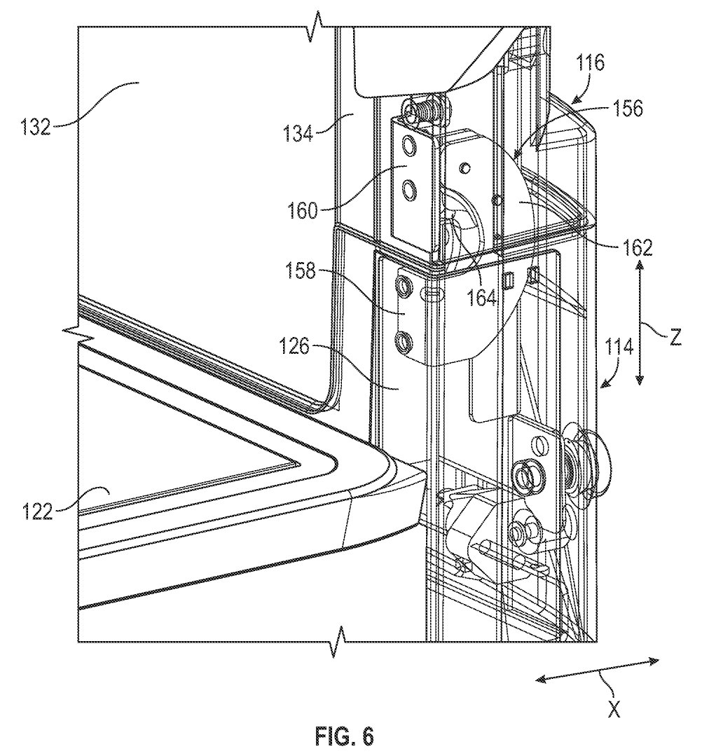

In at least one example, the lower hinges 156 can be sliding hinges. FIG. 6 depicts a close-up view of one of the lower hinges 156 (the second lower hinge). As illustrated in FIG. 6, the lower hinge 156 includes a base leaf 158 coupled with the post 126. The base leaf 158 can be bolted to a front wall of the post 126, for example. The lower hinge 156 also includes a panel leaf 160 coupled with the back panel 116. The panel leaf 160 can be bolted to a front wall or a mounting bracket of the display housing 134, for example. In one or more examples, the base leaf 158 and the panel leaf 160 can be arranged parallel to one another, e.g., in a plane perpendicular to the X-direction. The lower hinge 156 can also include a hinge base 162 and a slider 164 that is slidable relative to the hinge base 162. The hinge base 162 can be coupled with the base leaf 158 and the slider 164 can be coupled with the panel leaf 160. The slider 164 can include a slot in which one or more bearings extending from the hinge base 162 are received. The slider 164 can be slidable (in a rotary manner) between a retracted position in which the slider 164 is retracted within the hinge base 162 (corresponding to an unfolded position of the back panel 116 relative to the base 114) and an extended position in which the slider 164 is extended relative to the hinge base 162 (corresponding to a folded position of the back panel 116 relative to the base 114). In FIG. 6, the slider 164 is shown in the retracted position, and in this manner, the back panel 116 is unfolded relative to the base 114. In FIGS. 4 and 5, the slider 164 is shown in the extended position, and in this regard, the back panel 116 is folded relative to the base 114. In at least one example, the lower hinges 156 can allow the back panel 116 to be folded relative to the base 114 by substantially ninety degrees (90°), such as within ten degrees (10°) of ninety degrees (90°).

Further, in one or more examples, the halo 118 can be pivotably coupled with the back panel 116 for rotation about a second pivot axis AX2 so that the halo 118 is movable relative to the back panel 116 between a folded position and an unfolded position. In FIG. 1, the halo 118 is shown in the unfolded position. In the unfolded position, the halo 118 is arranged substantially perpendicular to the back panel 116, such as at least within ten degrees (10°) of ninety degrees (90°), e.g., as shown in FIG. 1. In FIGS. 2, 3, 4, and 5, the halo 118 is illustrated in the folded position. In the folded position, the halo 118 is arranged substantially parallel to the base 114 and the back panel 116, such as at least within ten degrees (10°) of one another. The second pivot axis AX2 can extend along the Y-direction, for example. In this regard, the first pivot axis AX1 and the second pivot axis AX2 can be substantially parallel, such as at least within ten degrees (10°) of one another.

To facilitate the folding and unfolding action of the halo 118 relative to the back panel 116, the foldable self-checkout kiosk 100 can include at least one upper hinge 166. The upper hinge 166 can be disposed along the second pivot axis AX2 and can be arranged to pivotably couple the halo 118 with the back panel 116. In at least one example, the upper hinge 166 can be disposed, at least in part, in the back panel 116 arranged at the second side 108, e.g., as shown in FIGS. 2, 3, 4, and 5. In other examples, the upper hinge 166 can be disposed, at least in part, in the back panel 116 arranged at the first side 106. In yet other examples, the upper hinge 166 can be one of a plurality of upper hinges. A first upper hinge of the plurality of upper hinges can be disposed, at least in part, in the back panel 116 arranged at the first side 106 while a second upper hinge can be disposed, at least in part, in the back panel 116 arranged at the second side 108.

In at least one example, the upper hinge 166 is arranged to be concealed within the back panel 116 and the halo 118 when the halo 118 is in the unfolded position, e.g., as shown in FIG. 1. In FIG. 1, the upper hinge 166 is not visible. In this regard, the upper hinge 166 can be an “invisible hinge” that can be hidden from view when the foldable self-checkout kiosk 100 is in the deployed position, which can enhance the safety of the foldable self-checkout kiosk 100, among other benefits.

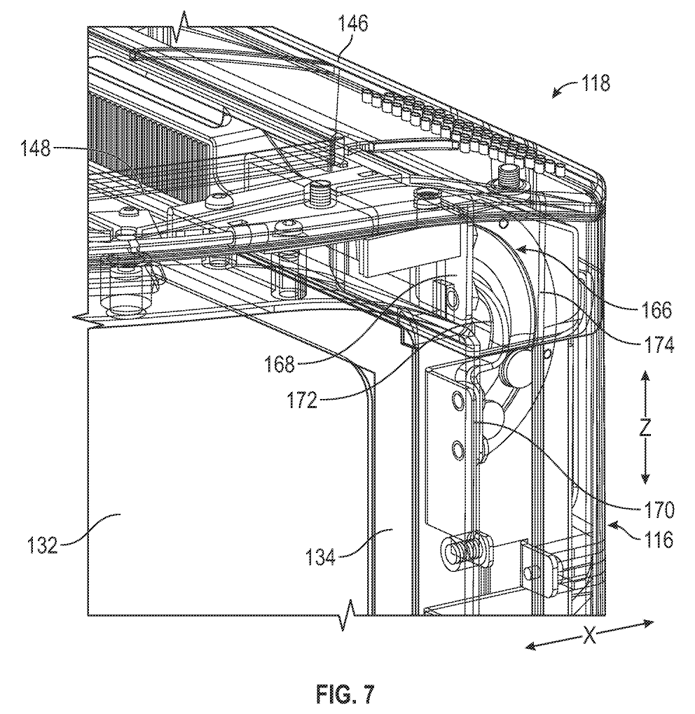

In at least one example, the upper hinge 166 can be a sliding hinge. FIG. 7 depicts a close-up view of the upper hinge 166. As illustrated in FIG. 7, the upper hinge 166 includes a halo leaf 168 coupled with the halo 118. The halo leaf 168 can be bolted to a bracket arranged within an interior of the halo 118, for example. The upper hinge 166 also includes a panel leaf 170 coupled with the back panel 116. The panel leaf 170 can be bolted to a front wall or mounting bracket of the display housing 134, for example. In one or more examples, the halo leaf 168 and the panel leaf 170 can be arranged parallel to one another, e.g., in a plane perpendicular to the X-direction. The upper hinge 166 can also include a hinge base 172 and a slider 174 (FIG. 5) that is slidable relative to the hinge base 172. The hinge base 172 can be coupled with the halo leaf 168 and the slider 174 can be coupled with the panel leaf 170. The slider 174 can include a slot in which one or more bearings extending from the hinge base 172 are received. The slider 174 can be slidable (in a rotary manner) between a retracted position in which the slider 174 is retracted within the hinge base 172 (corresponding to an unfolded position of the halo 118 relative to the back panel 116) and an extended position in which the slider 174 is extended relative to the hinge base 172 (corresponding to a folded position of the halo 118 relative to the back panel 116). In FIGS. 2, 3, 4, and 5, the slider 174 is shown in the extended position, and in this regard, the halo 118 is folded relative to the back panel 116. In at least one example, the upper hinge 166 can allow the halo 118 to be folded relative to the back panel 116 by substantially ninety degrees (90°), such as within ten degrees (10°) of ninety degrees (90°).

An example manner in which the foldable self-checkout kiosk 100 can be moved from the deployed position (FIG. 1) to the stowed position (FIGS. 4 and 5) will now be described with reference to FIGS. 1 through 5.

Starting from the deployed position of the foldable self-checkout kiosk 100 as shown in FIG. 1, the foldable self-checkout kiosk 100 can be moved to the stowed position by rotating the halo 118 relative to the back panel 116 about the second pivot axis AX2 so that the halo 118 is moved from an unfolded position (FIG. 1) to a folded position (FIGS. 2 and 3). The upper hinge 166 can allow the halo 118 to pivot or rotate in a downward direction (a counterclockwise direction as viewed in FIG. 3) about ninety degrees (90°). With the halo 118 folded down, the overhead camera 150 faces the display 132 and the forward-facing camera 152 faces downward toward the platform 122 as depicted in FIGS. 2 and 3.

In one or more examples, prior to rotating the halo 118 downward to its folded position, a locking mechanism, which can lock the halo 118 in its unfolded position, can be unlocked. With the locking mechanism unlocked, the halo 118 can be rotated downward to its folded position. In at least one example, the locking mechanism can include one or more of the following: a locking tab, a locking cam, bolted connections, latch, hasp, an electromagnetically controlled lock, etc. In at least one example, the locking mechanism can be “invisible” or hidden from view when the foldable self-checkout kiosk 100 is in the deployed position.

With the halo 118 in its folded position, the back panel 116 can be rotated relative to the base 114 about the first pivot axis AX1 so that the back panel 116 moved from an unfolded position (FIGS. 1, 2, and 3) to a folded position (FIGS. 4 and 5). In at least one example, starting from its unfolded position, the back panel 116 can rotate about the first pivot axis AX1 in the forward direction (a counterclockwise direction as viewed in FIG. 5) so that, when in its folded position, the back panel 116 is folded over the base 114, e.g., as shown in FIGS. 4 and 5. The lower hinges 156 can allow the back panel 116 to pivot or rotate downward in the forward direction about ninety degrees (90°).

When the back panel 116 and the halo 118 are in their respective folded positions, the halo 118 is arranged between the back panel 116 and the base 114, e.g., as shown in FIGS. 4 and 5. This can advantageously protect the halo 118 and its components during storage or transport. As shown in FIG. 5, when the back panel 116 and the halo 118 are in their respective folded positions, the overhead camera 150 and the forward-facing camera 152 camera of the halo 118 are arranged between the back panel 116 and the base 114, and thus are protected by the back panel 116 and the base 114. In addition, when the back panel 116 and the halo 118 are in their respective folded positions, the side cameras 140, 142 (only the side camera 142 is depicted in FIG. 5) arranged on opposing sides of the display 132 of the back panel 116 are arranged face down. This can provide protection for the side cameras 140, 142. Further, in at least one example, when the back panel 116 is arranged in the folded position, e.g., as illustrated in FIGS. 4 and 5, the display 132 of the back panel 116 and a top surface of the platform 122 can be arranged substantially parallel to, and spaced from, one another, e.g., along the Z-direction. With the back panel 116 folded over the base 114, the display 132 and the platform 122 can be protected during storage and/or transport.

In one or more examples, by folding the halo 118 relative to the back panel 116 and folding the back panel 116 relative to the base 114 to transition the foldable self-checkout kiosk 100 from the deployed position to the stowed position, the volumetric footprint of the foldable self-checkout kiosk 100 can be reduced. In at least one example, the volumetric footprint can be reduced by at least half in the foldable self-checkout kiosk 100 going from the deployed position to the stowed position. In at least one example, a vertical dimension of the foldable self-checkout kiosk 100 can be reduced by at least half, and in one or more examples, by at least three-fifths in the foldable self-checkout kiosk 100 going from the deployed position to the stowed position. In this manner, the halo 118 and the back panel 116 can be strategically folded so that the foldable self-checkout kiosk 100 is compact for storage and/or transport. Furthermore, in addition to the volumetric footprint reduction and the vertical dimension reduction, the halo 118 can remain coupled with the back panel 116 and the back panel 116 can remain coupled with the base 114 in the stowed position, which can reduce the time needed to “break down” the foldable self-checkout kiosk 100 to the stowed position and can also reduce the time needed to “setup” the foldable self-checkout kiosk 100 for redeployment.

An example manner in which the foldable self-checkout kiosk 100 can be moved from the stowed position (FIGS. 4 and 5) to the deployed position (FIG. 1) will now be described with reference to FIGS. 1 through 5.

Starting from the stowed position of the foldable self-checkout kiosk 100 as shown in FIGS. 4 and 5, the foldable self-checkout kiosk 100 can be moved to the deployed position by rotating the back panel 116 relative to the base 114 about the first pivot axis AX1 so that the back panel 116 moved from the folded position (FIGS. 4 and 5) to the unfolded position (FIGS. 2 and 3). In at least one example, starting from its folded position, the back panel 116 can rotate about the first pivot axis AX1 in the rearward direction (a clockwise direction as viewed in FIG. 5) so that, when in its unfolded position, the back panel 116 becomes arranged upright or vertically-oriented, e.g., as shown in FIGS. 2 and 3. The lower hinges 156 can allow the back panel 116 to pivot or rotate upward in the rearward direction about ninety degrees (90°). In the unfolded position, the back panel 116 is arranged substantially perpendicular to the base 114, such as at least within ten degrees (10°) of ninety degrees (90°), e.g., as shown in FIG. 3.

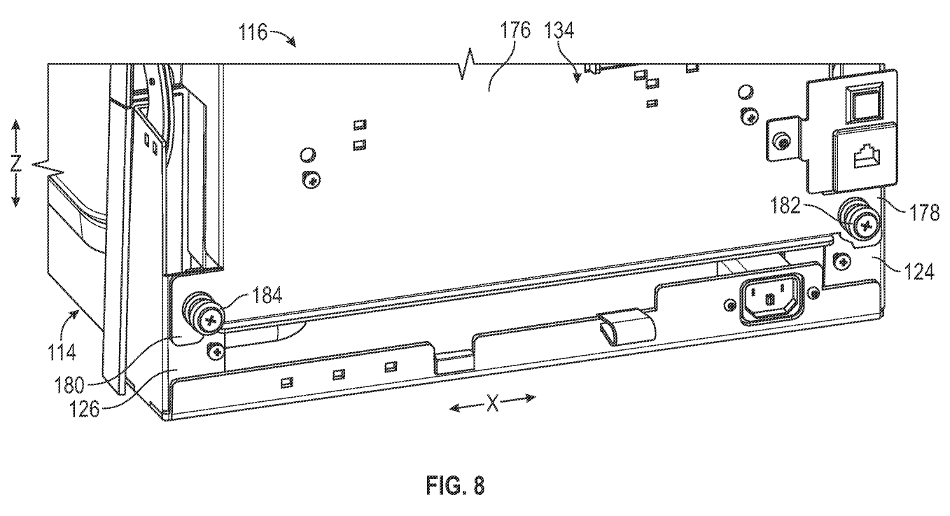

In one more examples, as shown in FIG. 8, the display housing 134 of the back panel 116 can include a back wall 176 having a pair of tabs 178, 180 that respectively engage back walls of the posts 124, 126 when the back panel 116 is moved to the unfolded position. In this regard, the pair of tabs 178, 180 can function as mechanical stops. Further, in at least some examples, fasteners 182, 184 can be arranged to secure the tabs 178, 180 to their respective posts 124, 126, which can lock the back panel 116 in its unfolded position.

With the back panel 116 in its unfolded position, the halo 118 can be rotated relative to the back panel 116 about the second pivot axis AX2 so that the halo 118 is moved from the folded position (FIGS. 4 and 5) to the unfolded position (FIGS. 2 and 3). The upper hinge 166 can allow the halo 118 to pivot or rotate in an upward direction (a clockwise direction as viewed in FIG. 3) about ninety degrees (90°). With the halo 118 moved to the unfolded position, the overhead camera 150 faces downward toward the platform 122 of the base 114 and the forward-facing camera 152 faces forward as depicted in FIGS. 2 and 3. In one or more examples, after rotating the halo 118 upward to its unfolded position, the locking mechanism can be locked, e.g., to ensure that the halo 118 is not advertently folded during operation of the foldable self-checkout kiosk 100.

By unfolding the halo 118 relative to the back panel 116 and unfolding the back panel 116 relative to the base 114, the foldable self-checkout kiosk 100 can be transitioned from the stowed position to the deployed position. Accordingly, the foldable self-checkout kiosk 100 can be deployed for use, e.g., in a retail store as a self-service checkout system. Notably, in setup of the foldable self-checkout kiosk 100, the back panel 116 can be moved to its unfolded position and the halo 118 can be moved to its unfolded position with an intuitive sequence that does not involve connecting or mating the halo 118 with the back panel 116 or the back panel 116 with the base 114. Indeed, these sections of the foldable self-checkout kiosk 100 are already coupled with one another (as they can remain coupled when the foldable self-checkout kiosk 100 is in the stowed position). Thus, setup of the foldable self-checkout kiosk 100 can be readily accomplished.

In one or more examples, with the foldable self-checkout kiosk 100 in the deployed position, one or more of the cameras 140, 142, 150, 152 can undergo an alignment check. As one example, after moving the foldable self-checkout kiosk 100 to the deployed position, images captured by the cameras 140, 142, 150, 152 can be routed to the computing system 154 for processing. The computing system 154 can use the currently captured images, e.g., to identify the current field of view of each one of the cameras 140, 142, 150, 152. The currently captured images can be compared to baseline images, e.g., to determine whether the field of view of a given one of the cameras 140, 142, 150, 152 is in a predefined range of a baseline field of view of the given camera. In at least one example, when a given one of the cameras 140, 142, 150, 152 is not within the predefined range of its baseline field of view, the computing system can generate and communicate a notification indicating that the given camera is out of alignment.

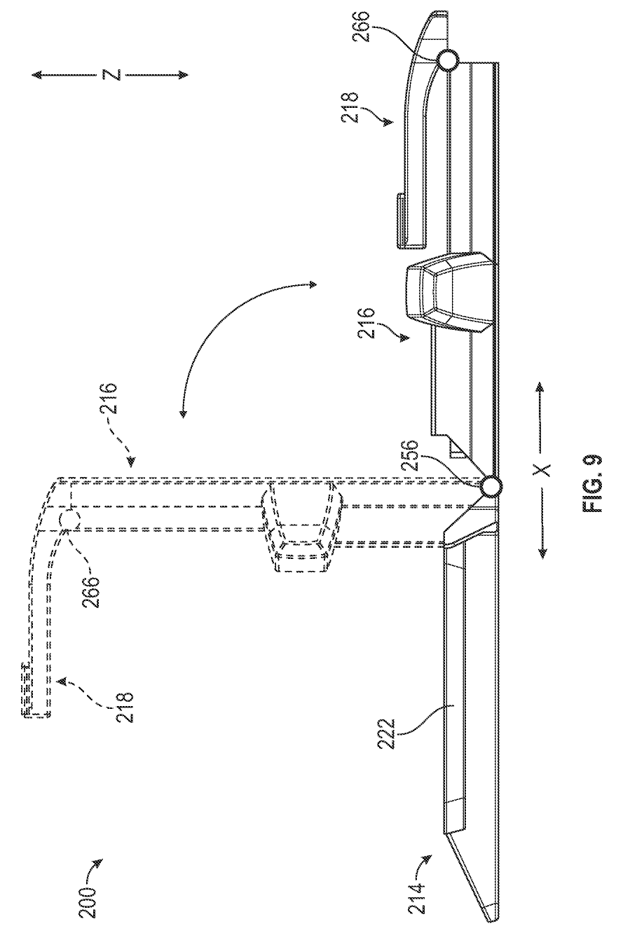

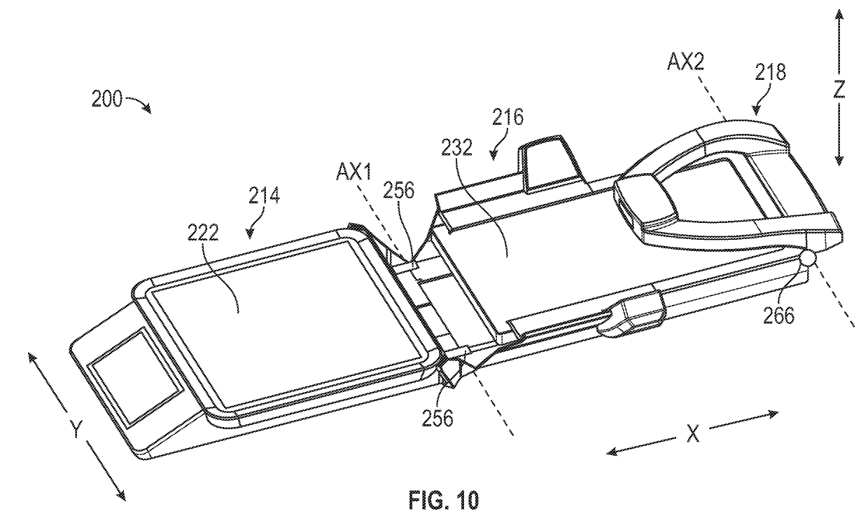

FIGS. 9 and 10 illustrate a side view and a perspective view of an exemplary foldable self-checkout kiosk 200, according to one or more aspects of the present disclosure. The foldable self-checkout kiosk 200 is configured in a similar manner as the foldable self-checkout kiosk 100 described herein, except as otherwise provided below.

As shown in FIGS. 9 and 10, the foldable self-checkout kiosk 200 includes a base 214, a back panel 216, and a halo 218. The foldable self-checkout kiosk 200 is movable between a deployed position and a stowed position. In FIGS. 9 and 10, the foldable self-checkout kiosk 200 is arranged in the stowed position. In FIG. 9, the foldable self-checkout kiosk 200 is also shown in the deployed position, with the back panel 216 and the halo 218 being depicted in phantom lines. In the deployed position, the back panel 216 is arranged substantially perpendicular to the base 214, and the halo 218 is arranged substantially perpendicular to the back panel 216 and parallel with the base 214. When the foldable self-checkout kiosk 200 is in the stowed position, the back panel 216 is arranged substantially parallel to the base 214, and the halo 218 is arranged substantially parallel to the back panel 216.

The back panel 216 is pivotably coupled with the base 214 for rotation about a first pivot axis AX1 so that the back panel 216 is movable relative to the base 214 between a folded position and an unfolded position. In FIGS. 9 and 10, the back panel 216 is arranged in a folded position. However, the back panel 216 is shown in the unfolded position in phantom lines in FIG. 9. One or more lower hinges 256 can facilitate rotation of the back panel 216 relative to the base 214 about the first pivot axis AX1.

In one or more examples, the back panel 216 can be rotated about the first pivot axis AX1 so as to “fold open”. As shown in FIGS. 9 and 10, the back panel 216 is rotatable about the first pivot axis AX1 in a rearward direction so that, when in the folded position, the back panel 216 is arranged so that a display 232 thereof is arranged face up (rather than being face down as when the back panel 116 of the foldable self-checkout kiosk 100 is folded over the base 114 as shown in FIG. 5). In FIG. 9, the rearward direction is a clockwise direction about the first pivot axis AX1. Accordingly, in the stowed position, the back panel 216 is laid flat on its back and arranged coplanar with the base 214. A platform 222 of the base 214 is also arranged face up.

The halo 218 is pivotably coupled with the back panel 216 for rotation about a second pivot axis AX2 so that the halo 218 is movable relative to the back panel 216 between a folded position and an unfolded position. In FIGS. 9 and 10, the halo 218 is arranged in a folded position. However, the halo 218 is shown in the unfolded position in phantom lines in FIG. 9. One or more upper hinges 266 can facilitate rotation of the halo 218 relative to the back panel 216 about the second pivot axis AX2. As depicted in FIGS. 9 and 10, the halo 218 can “fold over” the back panel 216. In this regard, a portion of the display 232 is arranged underneath the halo 218.

In one or more examples, by folding the halo 218 relative to the back panel 216 and folding the back panel 216 relative to the base 214 to transition the foldable self-checkout kiosk 200 from the deployed position to the stowed position, the volumetric footprint of the foldable self-checkout kiosk 200 can be reduced. In at least one example, the volumetric footprint can be reduced by at least half in the foldable self-checkout kiosk 200 going from the deployed position to the stowed position. In at least one example, a vertical dimension of the foldable self-checkout kiosk 200 can be reduced by at least half, and in one or more examples, by at least three-quarters in the foldable self-checkout kiosk 200 going from the deployed position to the stowed position. In this manner, the halo 218 and the back panel 216 can be strategically folded so that the foldable self-checkout kiosk 200 is compact for storage and/or transport. Furthermore, in addition to the volumetric footprint reduction and the vertical dimension reduction, the halo 218 can remain coupled with the back panel 216 and the back panel 216 can remain coupled with the base 214 in the stowed position, which can reduce the time needed to “break down” the foldable self-checkout kiosk 200 to the stowed position and can also reduce the time needed to “setup” the foldable self-checkout kiosk 200 for redeployment.

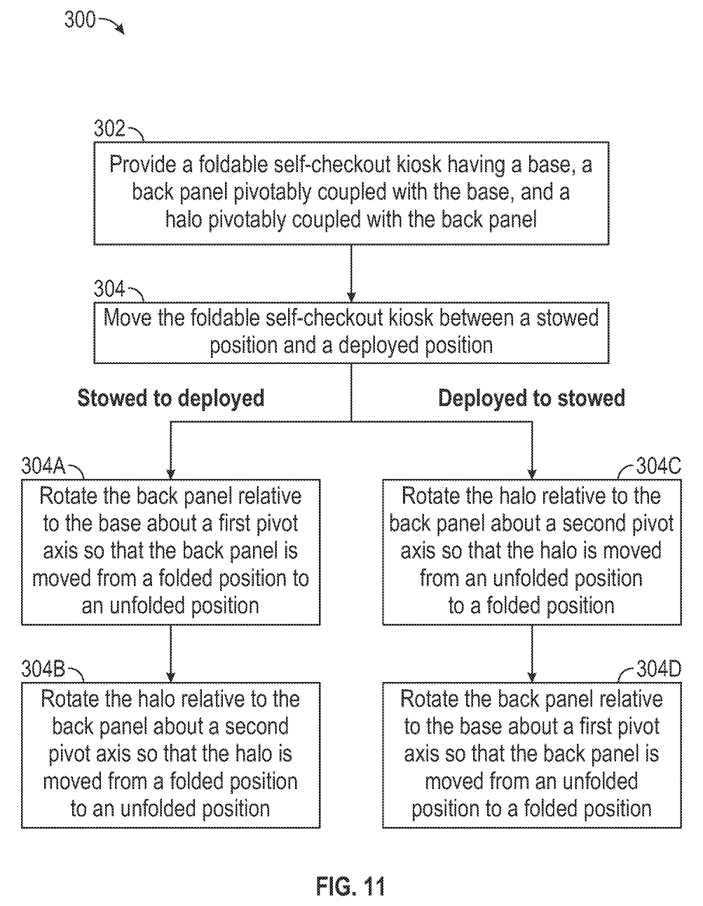

FIG. 11 is a flow diagram for a method 300 of transitioning a foldable self-checkout kiosk between a deployed position and a stowed position, according to one or more aspects of the present disclosure.

At 302, the method 300 can include providing a foldable self-checkout kiosk having a base, a back panel pivotably coupled with the base, and a halo pivotably coupled with the back panel. For instance, the foldable self-checkout kiosk can be the foldable self-checkout kiosk 100 of FIGS. 1 through 8, the foldable self-checkout kiosk 200 of FIGS. 9 and 10, or a foldable self-checkout kiosk having another configuration.

At 304, the method 300 can include moving the foldable self-checkout kiosk between a stowed position and a deployed position. In at least one implementation, to move the foldable self-checkout kiosk from the stowed position to the deployed position, the method 300 can include executing 304A and then 304B. In at least one implementation, to move the foldable self-checkout kiosk from the deployed position to the stowed position, the method 300 can include executing 304C and then 304D.

In one or more example implementations in which the foldable self-checkout kiosk is moved from the stowed position to the deployed position, the method 300 can include executing 304A and 304B.

At 304A, the method 300 can include rotating the back panel relative to the base about a first pivot axis so that the back panel is moved from a folded position to an unfolded position. In at least one implementation, the back panel can be rotated relative to the base about the first pivot axis by at least ninety degrees so that the back panel is moved from the folded position to the unfolded position.

At 304B, the method 300 can include rotating the halo relative to the back panel about a second pivot axis so that the halo is moved from a folded position to an unfolded position. In at least one implementation, the halo can be rotated relative to the back panel about the second pivot axis by at least ninety degrees so that the halo is moved from the folded position to the unfolded position. In some implementations, in the deployed position in which the back panel and the halo are arranged in their respective unfolded positions, the back panel is arranged substantially perpendicular to the base (e.g., at least within ten degrees (10°) of ninety degrees (90°)) and the halo is arranged substantially perpendicular to the back panel (e.g., at least within ten degrees (10°) of ninety degrees (90°)).

In one or more example implementations in which the foldable self-checkout kiosk is moved from the deployed position to the stowed position, the method 300 can include executing 304C and 304D.

At 304C, the method 300 can include rotating the halo relative to the back panel about a second pivot axis so that the halo is moved from an unfolded position to a folded position. In at least one implementation, the halo can be rotated relative to the back panel about the second pivot axis by at least ninety degrees so that the halo is moved from the unfolded position to the folded position.

At 304D, the method 300 can include rotating the back panel relative to the base about a first pivot axis so that the back panel is moved from an unfolded position to a folded position. In at least one implementation, the back panel can be rotated relative to the base about the first pivot axis by at least ninety degrees so that the back panel is moved from the unfolded position to the folded position.

In at least one implementation, when the foldable self-checkout kiosk is in the stowed position in which the back panel and the halo are arranged in their respective folded positions, the back panel and the halo can be “folded over” the base. Moreover, a display of the back panel and a top surface of a platform of the base can be arranged substantially parallel to, and spaced from, one another and a camera of the halo can be arranged between the back panel and the base. This can protect the camera, the display, and the platform during storage or transport, for example. Such a stowed position can also advantageously reduce the vertical dimension and the volumetric footprint of the foldable self-checkout kiosk for a compact storage position.

In at least one implementation, when the foldable self-checkout kiosk is in the stowed position in which the back panel and the halo are arranged in their respective folded positions, the back panel can be “folded open” with respect to the base, and the halo can be “folded over” the back panel. In this manner, the display of the back panel can be facing upward and the halo can be folded over the display. Such a stowed position can advantageously reduce the vertical dimension and the volumetric footprint of the foldable self-checkout kiosk for a compact storage position.

In one or more aspects, the foldable sections of the foldable self-checkout kiosk can be folded manually, e.g., by a user pushing or pulling a section. In yet other aspects, the foldable self-checkout kiosk can include one or more actuators that can be controlled to fold or unfold the foldable sections. In at least one example, one or more electrically-driven actuators can be controlled to rotate the back panel relative to the base, and in addition or alternatively, one or more electrically-driven actuators can be controlled to rotate the halo relative to the back panel. The one or more electrically-driven actuators can be controlled by a computing system of the foldable self-checkout kiosk.

FIG. 12 is a block diagram of a computing system 400 for a foldable self-checkout kiosk. As one example, the computing system 154 of the foldable self-checkout kiosk 100 of FIGS. 1 through 8 can be configured in a same or similar manner as the computing system 400 of FIG. 12. The foldable self-checkout kiosk 200 of FIGS. 9 and 10 can include a computing system configured in a same or similar manner as the computing system 400 of FIG. 12.

As shown in FIG. 12, the computing system 400 can include a computing device 402. The computing device 402 can include one or more processor(s) 404 and one or more memory device(s) 406. The one or more processor(s) 404 can include any suitable processing device, such as a microprocessor, microcontroller, integrated circuit, logic device, or other suitable processing device. The one or more memory device(s) 406 can include one or more computer-readable medium, including, but not limited to, non-transitory computer-readable medium, RAM, ROM, hard drives, flash drives, and other memory devices.

The one or more memory device(s) 406 can store information accessible by the one or more processor(s) 404, including computer-readable instructions 408 or computer-readable program code that can be executed by the one or more processor(s) 404. The instructions 408 can be any set of instructions that when executed by the one or more processor(s) 404, cause the one or more processor(s) 404 to perform operations, such as operations associated with performing camera alignment checks after transitioning a foldable self-checkout kiosk from a stowed positon to a deployed position and/or activating actuators to perform folding actions of one or more foldable sections of the foldable self-checkout kiosk. The instructions 408 can be software written in any suitable programming language or can be implemented in hardware.

The memory device(s) 406 can further store data 410 that can be accessed by the processor(s) 404. For example, the data 410 can include any of the data noted herein. The data 410 can include one or more table(s), function(s), algorithm(s), model(s), equation(s), libraries, etc. according to example aspects of the present disclosure. In one aspect, the data 410 can include captured images and baseline images captured when the field of view of the cameras were known to be within a predefined range of a defined specification.

The computing device 402 can also include a communication interface 412 used to communicate, for example, with the other components of the foldable self-checkout kiosk. The communication interface 412 can include any suitable components for interfacing with one or more network(s), including for example, transmitters, receivers, ports, controllers, antennas, or other suitable components.

The descriptions of the various embodiments have been presented for purposes of illustration, but are not intended to be exhaustive or limited to the embodiments disclosed. Instead, any combination of the noted features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to one or more embodiments, other and further embodiments may be devised without departing from the basic scope thereof, and the scope thereof is determined by the claims that follow.

What is claimed is:

1. A foldable self-checkout kiosk, comprising:
a base;
a back panel pivotably coupled with the base for rotation about a first pivot axis so that the back panel is movable relative to the base between a folded position and an unfolded position; and
a halo pivotably coupled with the back panel for rotation about a second pivot axis so that the halo is movable relative to the back panel between a folded position and an unfolded position.

2. The foldable self-checkout kiosk of claim 1, wherein:
in the unfolded position, the back panel is arranged substantially perpendicular to the base, and
in the folded position, the back panel is arranged substantially parallel to the base.

3. The foldable self-checkout kiosk of claim 2, wherein the back panel is rotatable about the first pivot axis in a forward direction so that, when in the folded position, the back panel is folded over the base.

4. The foldable self-checkout kiosk of claim 2, wherein the back panel is rotatable about the first pivot axis in a rearward direction so that, when in the folded position, the back panel is arranged so that a display thereof is arranged face up.

5. The foldable self-checkout kiosk of claim 1, wherein:
in the unfolded position, the halo is arranged substantially perpendicular to the back panel, and
in the folded position, the halo is arranged substantially parallel to the base and the back panel.

6. The foldable self-checkout kiosk of claim 1, wherein, when the back panel and the halo are in their respective folded positions, the halo is arranged between the back panel and the base.

7. The foldable self-checkout kiosk of claim 1, wherein the first pivot axis and the second pivot axis are substantially parallel.

8. The foldable self-checkout kiosk of claim 1, wherein the base has a housing, a platform arranged on the housing, and posts extending upward relative to the housing and spaced from one another, and wherein the foldable self-checkout kiosk further comprises:
lower hinges disposed along the first pivot axis and arranged to pivotably couple the back panel with the posts of the base.

9. The foldable self-checkout kiosk of claim 8, wherein the lower hinges are sliding hinges and are arranged to be concealed within the posts and back panel when the back panel is in the unfolded position.

10. The foldable self-checkout kiosk of claim 1, further comprising:
an upper hinge disposed along the second pivot axis and arranged to pivotably couple the halo with the back panel.

11. The foldable self-checkout kiosk of claim 10, wherein the upper hinge is arranged to be concealed within the back panel and the halo when the halo is in the unfolded position.

12. The foldable self-checkout kiosk of claim 1, wherein, when the back panel and the halo are in their respective folded positions, a camera of the halo is arranged between the back panel and the base and cameras arranged on opposing sides of a display of the back panel are arranged face down.

13. The foldable self-checkout kiosk of claim 1, wherein the base has a platform arranged to weigh items, and wherein, when the back panel is arranged in the folded position, a display of the back panel and a top surface of the platform are arranged substantially parallel to, and spaced from, one another.

14. A foldable self-checkout kiosk, comprising:
a base having a platform;
a back panel having a display supported by a display housing and having a pair of cameras arranged on opposite sides of the display, wherein the back panel is pivotably coupled with the base for rotation about a first pivot axis so that the back panel is movable relative to the base between a folded position and an unfolded position; and
a halo having a camera, wherein the halo is pivotably coupled with the back panel for rotation about a second pivot axis so that the halo is movable relative to the display between a folded position and an unfolded position, and
wherein, when the back panel and the halo are arranged in their respective folded positions, the foldable self-checkout kiosk is arranged in a stowed position in which:
the display and a top surface of the platform are arranged substantially parallel to, and spaced from, one another;
the camera of the halo is arranged between the back panel and the base; and
the cameras of the back panel are arranged face down.

15. A method, comprising:
providing a foldable self-checkout kiosk having a base, a back panel pivotably coupled with the base, and a halo pivotably coupled with the back panel;
moving the foldable self-checkout kiosk between a stowed position and a deployed position, comprising:
rotating the back panel relative to the base about a first pivot axis so that the back panel is moved from a folded position to an unfolded position, or vice versa; and
rotating the halo relative to the back panel about a second pivot axis so that the halo is moved from a folded position to an unfolded position, or vice versa.

16. The method of claim 15, wherein moving the foldable self-checkout kiosk between the stowed position and the deployed position comprises:
rotating the back panel relative to the base about the first pivot axis by at least ninety degrees so that the back panel is moved from the folded position to the unfolded position; and
rotating the halo relative to the back panel about the second pivot axis by at least ninety degrees so that the halo is moved from the folded position to the unfolded position.

17. The method of claim 15, wherein moving the foldable self-checkout kiosk between the stowed position and the deployed position comprises:
rotating the halo relative to the back panel about the second pivot axis by at least ninety degrees so that the halo is moved from the unfolded position to the folded position; and
rotating the back panel relative to the base about the first pivot axis by at least ninety degrees so that the back panel is moved from the unfolded position to the folded position.

18. The method of claim 15, wherein in the stowed position in which the back panel and the halo are arranged in their respective folded positions, a display of the back panel and a top surface of a platform of the base are arranged substantially parallel to, and spaced from, one another and a camera of the halo is arranged between the back panel and the base.

19. The method of claim 15, wherein in the stowed position in which the back panel and the halo are arranged in their respective folded positions, a display of the back panel is facing upward and the halo is folded over the display.

20. The method of claim 15, wherein in the deployed position in which the back panel and the halo are arranged in their respective unfolded positions, the back panel is arranged substantially perpendicular to the base and the halo is arranged substantially perpendicular to the back panel.
